(19) United States
(12) Patent Application Publication
(10) Pub. No.: US 2025/0183394 A1
(43) Pub. Date: Jun. 5, 2025

(54) THERMAL EVENT IDENTIFICATION

(71) Applicant: Caterpillar Inc., Peoria, IL (US)

(72) Inventors: Siddartha Saikia, Chennai (IN); Luvkush Kumar, Muthura (IN)

(73) Assignee: Caterpillar Inc., Peoria, IL (US)

(21) Appl. No.: 18/524,442

(22) Filed: Nov. 30, 2023

(51) Int. Cl. H01M 10/48; G01K 3/00; G01K 7/26; G01K 11/12

(52) U.S. Cl. CPC H01M 10/486; G01K 3/005; H01M 10/482; G01K 7/26; G01K 11/12

(57) ABSTRACT

A thermal event identification device for detecting thermal events in a battery pack with at least one battery cell. The thermal identification device includes a heat sensitive component, an electrically conductive substrate and a capsule containing an electrolyte. Below a lower threshold temperature, the substrate has a first resistance value. When the heat sensitive component is heated above the threshold temperature the electrolyte is released from the capsule and the substrate is soaked in the electrolyte. This changes the resistance of the substrate to a different resistance value. By measuring the resistance of the electrically conductive substance, a controller can determine whether a thermal event has occurred. The heat sensitive component is positioned adjacent to a battery cell to identify thermal events related to the battery cell.

### FIELD OF THE DISCLOSURE

The disclosure relates to the field of identifying thermal events. In particular, the disclosure relates to identification of thermal events in battery cells of a battery pack.

### BACKGROUND

Battery packs are known to contain more than one battery cell, either arranged in parallel or in series or in a combination of parallel and series. Batteries are known to be sensitive to temperature. In particular, it is often preferable to operate batteries below a maximum operating temperature. Above a maximum operating temperature for a particular battery, the performance of the battery may deteriorate, a potential failure of a battery cell may occur or a safety risk may increase. This can especially be the case for Lithium batteries or other rechargeable batteries, in which there is a risk that thermal runaway can occur at high temperatures. Thermal runaway is a phenomenon in which a battery enters a self-heating state, and can be an issue if a rechargeable battery is handled improperly, or if there are defects or faults in the battery. As an example, certain Lithium batteries can operate safely at temperatures up to between 6° and 75° C. Thermal runaway may occur in these batteries at a temperature in the region of 85 to 110° C. However, these temperatures vary depending on battery chemistry. It may be beneficial to identify if a temperature of a battery has risen above a certain temperature.

As a safety feature, many rechargeable batteries have a separator that is configured to disable the battery cell when the battery cell exceeds a threshold temperature. The separator may allow exchange of ions between the cathode and the anode via the separator at temperatures below the threshold temperature and may prevent exchange of ions through the separator at temperatures above the threshold temperature, so preventing thermal runaway in most cases. For example, the separator may melt at the threshold temperature, permanently disabling the cell. An example of such a separator is a tri-layer cell separator comprising a layer of polyethylene between two layers of polypropylene. In an event that a battery cell undergoes such a failure, it is beneficial to be able to identify that battery cell.

It is known to identify disabled battery cells by measuring their impedance. However, for battery cells arranged in a parallel configuration it is not possible to measure the impedance of individual battery cells. Although it is possible to measure impedance of individual battery cells that are in a series configuration, this can be time consuming.

As an alternative to direct measurement of whether a battery cell has been disabled, it is known to monitor the temperature of the battery cell to determine whether the temperature at which the separator melts has been exceeded. This may be achieved by having a thermistor in each cell, although this can be costly. Alternatively, thermo-chromatic stickers are available that change colour at certain temperatures. A sticker can be adhered to each battery cell, providing a visual indication of whether a particular temperature has been exceeded. However, battery cells are often contained within a sealed housing. The stickers may be viewed only by opening that housing. Generally, the housing is not opened in use or by technicians, so the visual indication of the temperature change is not accessible.

### SUMMARY

Against this background and according to a first aspect of the disclosure, there is provided a thermal event identification device for a battery pack comprising at least one battery cell. The thermal identification device comprises a heat sensitive component comprising a substrate and a capsule containing an electrolyte, wherein the substrate is electrically conductive. Below a first temperature, a resistance of the substrate has a first resistance value. In an event that the heat sensitive component is heated to above the first temperature the electrolyte is released from the capsule such that the substrate is soaked in the electrolyte and the resistance of the substrate changes to a second resistance value. The thermal identification device further comprises a first electrical connection and a second electrical connection, wherein the heat sensitive component is electrically connected to the first and second electrical connections such that a resistance of the substrate of the heat sensitive component can be measured. The thermal identification device further comprises a controller configured to determine whether a thermal event has occurred based on the resistance of the heat sensitive component. In use, the heat sensitive component is configured to be adjacent to a battery cell.

In this way, a battery cell in a battery pack that has exceeded a threshold temperature can be identified and located. The thermal event identification device may be used to determine whether a battery cell has exceeded the temperature at which a separator is configured to disable the battery cell, such that any disabled battery cells can be removed and replaced. The thermal event identification device may be used to determine whether a battery has exceeded a temperature at which issues are known to be at risk of arising, such as thermal runaway. This may allow a battery cell to be replaced before it fails or is disabled.

According to a second aspect of the present disclosure, there is provided a battery pack comprising two or more battery cells and a thermal event identification device according to the first aspect of the disclosure, wherein each heat sensitive component is adjacent to a battery cell.

According to a third aspect of the present disclosure there is provided a method of identifying whether a thermal event has occurred in a battery cell of a battery pack, the method comprising measuring the resistance of a heat sensitive component adjacent to the battery cell. The heat sensitive component comprises a substrate and a capsule containing an electrolyte. The heat sensitive component is electrically conductive. Below a first temperature, the substrate has a first resistance value. In an event that the heat sensitive component is heated to above the first temperature the electrolyte is released from the capsule such that the substrate is soaked in the electrolyte and the resistance of the substrate changes to a second resistance value. The heat sensitive component is electrically connected to a first electrical connection and a second electrical connection such that a resistance of the substrate of the heat sensitive component can be measured, wherein in an event that the measured resistance is below a threshold resistance, a thermal event has occurred in the battery cell adjacent to the heat sensitive component. The method further comprises comparing the measured resistance to the threshold resistance.

### BRIEF DESCRIPTION OF THE DRAWINGS

A specific embodiment of the disclosure will now be described, by way of example only, with reference to the accompanying drawings in which:

FIG. 1 shows a schematic diagram of a first heat sensitive component and a second heat sensitive component of a thermal identification device according to an embodiment of the present disclosure.

FIG. 2 shows a schematic diagram of an array of heat sensitive components of a thermal identification device according to an embodiment of the present disclosure.

FIG. 3 shows a schematic cross-sectional diagram of the structure of a heat sensitive component of a thermal identification device according to an embodiment of the present disclosure.

FIG. 4 shows flowchart illustrating a method of identifying whether a thermal event has occurred in a battery cell according to an embodiment of the present disclosure.

### DETAILED DESCRIPTION

According to an embodiment of the present disclosure, a thermal event identification device is provided for a battery pack comprising at least one battery cell. The thermal event identification device comprises a heat sensitive component. The heat sensitive component comprises a substrate and a capsule containing an electrolyte. The substrate is electrically conductive. Below a first temperature, a resistance of the substrate has a first resistance value. In an event that the heat sensitive component is heated to above the first temperature the electrolyte is released from the capsule such that the substrate is soaked in the electrolyte and the resistance of the substrate changes to a second resistance value. The thermal identification device further comprises a first electrical connection and a second electrical connection. The heat sensitive component is electrically connected to the first and second electrical connections such that a resistance of the substrate of the heat sensitive component can be measured. The thermal identification device further comprises a controller configured to determine whether a thermal event has occurred, based on the resistance of the heat sensitive component. In use, the heat sensitive component is configured to be adjacent to a battery cell.

In certain embodiments, the second resistance value is lower than the first resistance value.

The first and second electrical connections are connected to the heat sensitive component such that current is able to flow through the heat sensitive component from the first electrical connection to the second electrical connection, or from the first electrical connection to the second electrical connection. In other words, a current path is possible along the first electrical connection, through the heat sensitive component and along the second electrical connection (or vice versa, with a current path along the second electrical connection, through the heat sensitive component and along the first electrical connection). In this context, the first and electrical connections are wires or other electrically conducting elements that can be used to connect the heat sensitive component to a device, circuit or component for measuring resistance.

In use, the controller can be used to monitor the resistance of the substrate. As the heat sensitive component is, in use, configured to be adjacent to a battery cell, the temperature of the heat sensitive component is affected by the temperature of the battery cell. If the temperature of the battery cell increases then the temperature of the heat sensitive component increases, and if the temperature of the battery cell decreases then the temperature of the heat sensitive component decreases. The temperature of the heat sensitive component may be similar to the temperature of the battery cell or may be offset from the temperature of the battery cell. In an event that the resistance of the substrate is equal or near to the first resistance value, this indicates that the capsule is intact and so temperature of heat sensitive component has not risen above the first temperature. This, in turn, indicates that a temperature of the battery has not risen above a threshold temperature. In an event that the resistance of the substrate is equal or near to the second resistance value, this indicates that the electrolyte has been released from the capsule and so temperature of heat sensitive component has risen above the first temperature. This, in turn, indicates that a temperature of the battery has risen above a threshold temperature.

In certain embodiments, the thermal identification device comprises two or more heat sensitive components and at least one additional electrical connection. Each heat sensitive component is electrically connected to two electrical connections such that a resistance of the substrate of each heat sensitive component can be measured individually. The controller is configured to determine whether a thermal event has occurred at each heat sensitive component based on the resistance of each heat sensitive component. In use, each heat sensitive component is configured to be adjacent to a battery cell.

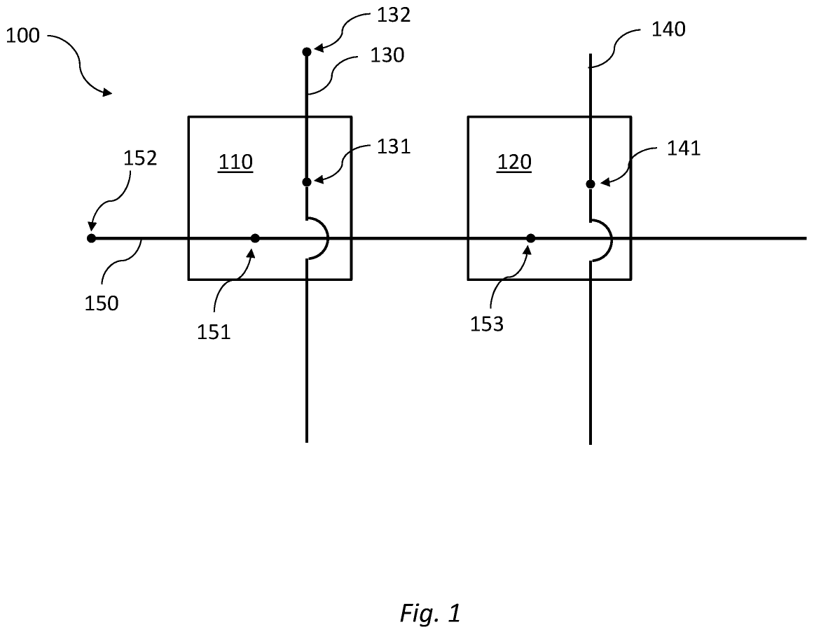

In certain embodiments where the thermal identification device comprises two or more heat sensitive components, a given electrical connection may be connected to more than one heat sensitive component. Each heat sensitive component may be connected to a unique combination of electrical connections, such that a resistance of each heat sensitive component can be measured individually. In a simple example, with reference to FIG. 1, a thermal identification device 100 may comprise a first heat sensitive component 110 and second heat sensitive component 120. The first heat sensitive component 110 is connected to a first electrical connection 130 at 131 and to a second electrical connection 150 at 151. The second heat sensitive component 120 is connected to a third electrical connection 140 at 141 and to the second electrical connection 150 at 153. In an event that a resistance measurement is taken between points 132 and 152, current flows across the first heat sensitive component between 131 and 151, and a resistance measurement of the first heat sensitive component can be made. No current flows across the second heat sensitive component. In an event that a resistance measurement is taken between points 142 and 152, current flows across the second heat sensitive component between 141 and 153, and a resistance measurement of the second heat sensitive component can be made. The positions of the points at which the electrical connections are connected to the heat sensitive components are for illustrative purposes only. The electrical connections may be connected to each heat sensitive component such that the resistance measurement is made in the plane of the heat sensitive component or such that the resistance measurement is made through the heat sensitive component, or in some other configuration.

In certain embodiments, the thermal identification device comprises more than two heat sensitive components. Each heat sensitive component is electrically connected to two electrical connections such that a resistance of the substrate of each heat sensitive component can be measured individually. The controller is configured to determine whether a thermal event has occurred at each heat sensitive component based on the resistance of each heat sensitive component. In use, each heat sensitive component is configured to be adjacent to a battery cell. In certain embodiments where the thermal identification device comprises more than two heat sensitive components, a given electrical connection may be connected to more than one heat sensitive component. Each heat sensitive component may be connected to a unique combination of electrical connections, such that a resistance of each heat sensitive component can be measured individually.

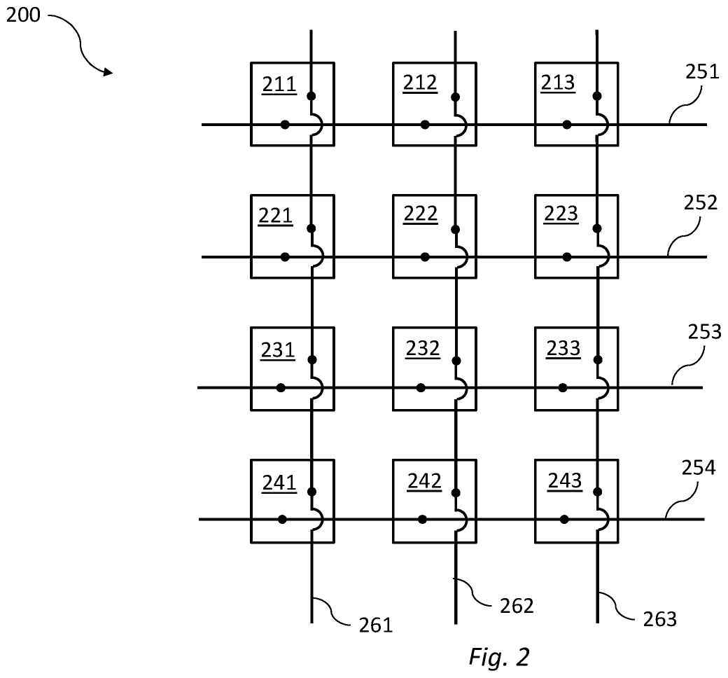

With reference to FIG. 2, a thermal identification device 200 is illustrated having an array of heat sensitive components 211, 212, 213, 221, 222, 223, 231, 232, 233, 241, 242 and 243. The first (top) row or heat sensitive components 211, 212, 213 are all connected to a first electrical connection 251. The second row of heat sensitive components 221, 222, 223 are all connected to a second electrical connection 252. The third row of heat sensitive components 231, 232, 233 are all connected to a third electrical connection 253. The fourth row of heat sensitive components 241, 242, 243 are all connected to a fourth electrical connection 254. The first (left hand) column of heat sensitive components 211, 221, 231, 241 are all connected to a fifth electrical connection 261. The second column of heat sensitive components 212, 222, 232, 242 are all connected to a sixth electrical connection 262. The third column of heat sensitive components 213, 223, 233, 243 are all connected to a seventh electrical connection 263. The points at which the heat sensitive components are connected to their respective electrical connections are shown by dots. In this way, each heat sensitive component can be addressed individually to measure its resistance. For example, using the second electrical connection 252 and the sixth electrical connection 262 allows the resistance of heat sensitive component 222 to be measured, and does not result in current flowing through any other heat sensitive component. The electrical connections may be connected to each heat sensitive component such that the resistance measurement is made in the plane of the heat sensitive component or such that the resistance measurement is made through the heat sensitive component, or in some other configuration.

The example illustrated in FIG. 2 shows twelve heat sensitive components and seven electrical connections. This is an example only. The thermal identification device may comprise any number of heat sensitive components and any number of electrical connections. FIG. 2 shows the heat sensitive components arranged in an array of rows and columns, allowing each heat sensitive component to be addressed by row-column. The heat sensitive components and electrical connections may be arranged in a different configuration to that shown in FIG. 2. Any arrangement of electrical connection that allows the resistance of each heat sensitive component to be measured individually is possible.

Each heat sensitive component comprises a capsule containing an electrolyte. In certain embodiments, the heat sensitive component may comprise more than one capsule containing an electrolyte. In certain embodiments, the heat sensitive component may comprise more than one microcapsule containing an electrolyte. A microcapsule may comprise a small sphere (typically 1000 microns or smaller in diameter) with a substantially uniform wall enclosing a core. The core comprises the electrolyte. The microcapsule may take other forms. For example, the wall may not be uniform, the microcapsule may have more than wall, or the microcapsule may be any other capsule that can contain an electrolyte.

The capsule(s) containing an electrolyte may be configured to rupture at a certain threshold temperature. When a capsule ruptures, the electrolyte is released into the substrate. The electrolyte soaks the substrate. In this context, soaking the substrate with electrolyte means that the electrolyte enters the substrate such that the electrical properties of the substrate change where the electrolyte is present.

In certain embodiments, the capsule(s) may be embedded in the substrate. In particular, microcapsules may be embedded in the substrate.

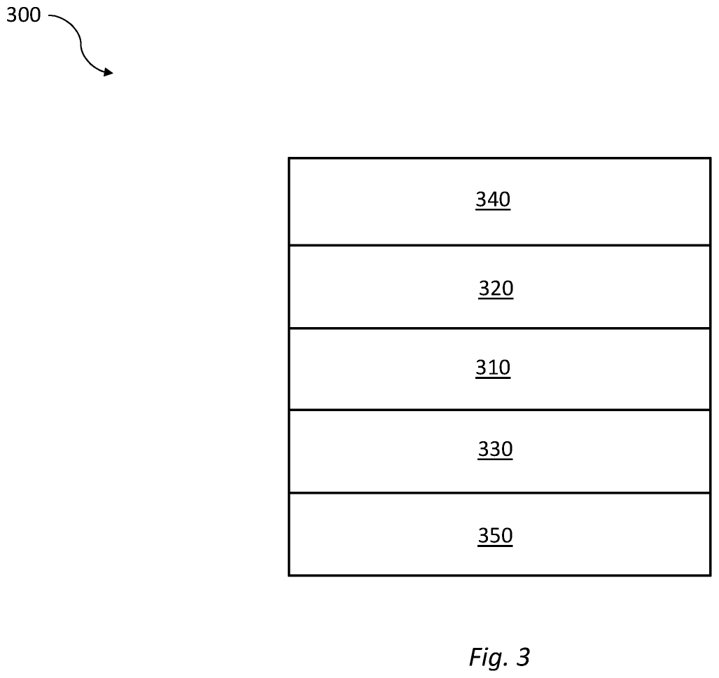

With reference to FIG. 3, in certain embodiments, a heat sensitive component 300 may comprise a substrate 310, wherein microcapsules are embedded in the substrate 310. The substrate 310 is positioned between a first layer of Aluminium foil 320 and a second layer of Aluminium foil 330. A first insulator 340 and a second insulator 350 are positioned adjacent to the first layer of Aluminium foil 320 and second layer of Aluminium foil 330, respectively. In an event that the heat sensitive component is heated to above the first temperature the electrolyte is released from the capsule such that the substrate is soaked in the electrolyte and the resistance of the substrate changes to a second resistance value. The measurement of the resistance of the heat sensitive component may be made through the heat sensitive component, such that the first electrical connection is connected to the first layer of aluminium foil 320 and the second electrical connection is connected to the second layer of aluminium foil 330 (or vice versa). The first and second layers of Aluminium foil may be replaced by other conducting layers. The first electrical connection may be connected to a first conducting layer and the second electrical connection may be connected to a second conducting layer, wherein the substrate is positioned between the first conducting layer and the second conducting layer such that the first and second conducting layer are electrically connected via the substrate.

The arrangement in FIG. 3 is an example only. Other arrangements are possible.

In an event that the heat sensitive component is heated to above the first temperature the electrolyte is released from the capsule such that the substrate is soaked in the electrolyte. In certain embodiments, the electrolyte may then dry on the substrate over time. The resistance of the substrate may remain at the second resistance value until the electrolyte dries. Once the electrolyte dries, the resistance of the substrate may return to the first resistance value. In other embodiments, once the electrolyte dries, the resistance of the substrate may remain at the second resistance value or may change to a third resistance value.

The substrate and the capsule(s) may be encased such that in an event that the heat sensitive component is heated to above the first temperature the electrolyte is released from the capsule such that the substrate is soaked in the electrolyte, the electrolyte does not dry and the resistance of the substrate remains at the second resistance value.

In certain embodiments, the heat sensitive component may be adhesive such that the heat sensitive component can be adhered to a battery cell.

In use, the heat sensitive component(s) may be placed adjacent to or adhered to a region of a battery cell that is visible in an event that the battery pack is opened. For example, the heat sensitive component(s) may be placed adjacent to or adhered to a top rim of a battery cell.

In certain embodiments, the controller may be configured to determine whether a thermal event has occurred based on the resistance of a heat sensitive component at regular intervals. In certain embodiments, the interval may be shorter than the length of time taken for the electrolyte to dry on the substrate. In an event that the thermal identification device comprises more than one heat sensitive component, the controller may be configured to determine the resistance of each heat sensitive component sequentially. The controller may be configured to repeat the sequential determination of the resistance of each heat sensitive component at regular intervals.

In certain embodiments, a heat sensitive component may comprise more than one type of capsule comprising an electrolyte, wherein each type of capsule is configured to release the electrolyte at a different temperature. In certain embodiments, the resistance of the substrate may have a different value depending on the electrolyte released. In this way, different temperatures reached by the heat sensitive component may be detected by measuring the resistance of the substrate.

An example of a suitable electrolyte is Lithium Hexa Fluoro Phosphate. However, other electrolytes may be used.

In use, the heat sensitive component is adjacent to a battery cell and so the temperature of the heat sensitive component is related to the temperature of the battery cell. The temperature of the heat sensitive component relative to the interior of the battery cell depends on the position of the heat sensitive component relative to the battery cell, and on how the temperature of the exterior of the battery cell is related to the temperature of the interior of the battery cell. The temperature of the heat sensitive component may track the temperature changes of the battery cell, such that in an event that the temperature of the battery cell increases, the temperature of the heat sensitive component increases. Similarly, in an event that the temperature of the battery cell decreases, the temperature of the heat sensitive component decreases. The magnitude of the temperature of the heat sensitive component may be offset from the temperature of the battery cell. The temperature at which the capsule releases the electrolyte may be calibrated based on the relationship between the temperature of the battery cell and the heat sensitive component.

The first resistance value may vary slightly depending on the ambient temperature and on the operating temperature of the battery cell. However, the variations in the first resistance value are smaller than the difference between the first resistance value and the second resistance value. In certain embodiments, the first resistance value may be a range of values above a threshold resistance value and the second resistance value may be a range of values below a threshold resistance value. Below a first temperature, a resistance of the substrate is in the first resistance value range. In an event that the heat sensitive component is heated to above the first temperature the electrolyte is released from the capsule such that the substrate is soaked in the electrolyte and the resistance of the substrate changes to a resistance in the second resistance value range. In certain examples, below a first temperature, a resistance of the substrate is above a threshold resistance. In an event that the heat sensitive component is heated to above the first temperature the electrolyte is released from the capsule such that the substrate is soaked in the electrolyte and the resistance of the substrate changes to below the threshold resistance.

As discussed, releasing the electrolyte alters the resistance of the substrate. In certain embodiments, the capsule may further contain a dye such that in an event that the heat sensitive component is heated to above the first temperature the dye is released from the capsule such that the substrate changes colour. In other embodiments, the thermal identification device may comprise additional capsules containing a dye such that in an event that the heat sensitive component is heated to above the first temperature the dye is released from the capsule such that the heat sensitive component changes colour. The colour change may be non-reversible.

There is also provided a method of identifying whether a thermal event has occurred in a battery cell of a battery pack. The method comprising measuring the resistance of a heat sensitive component adjacent to the battery cell. The heat sensitive component comprises a substrate and a capsule containing an electrolyte, wherein the heat sensitive component is electrically conductive. Below a first temperature, the substrate has a first resistance value. In an event that the heat sensitive component is heated to above the first temperature the electrolyte is released from the capsule such that the substrate is soaked in the electrolyte and the resistance of the substrate changes to a second resistance value. The heat sensitive component is electrically connected to a first electrical connection and a second electrical connection such that a resistance of the substrate of the heat sensitive component can be measured. In an event that the measured resistance is below a threshold resistance, a thermal event has occurred in the battery cell adjacent to the heat sensitive component.

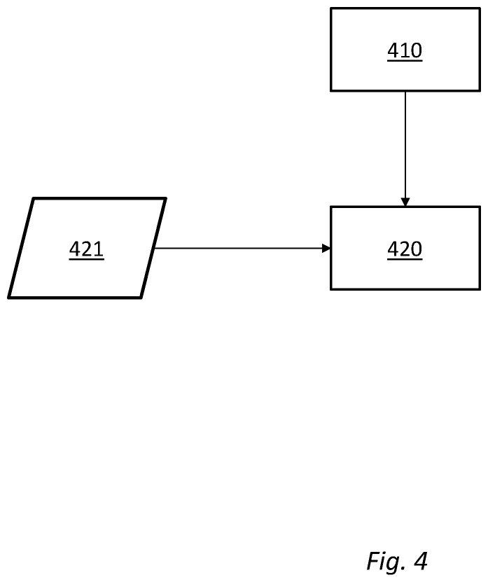

With reference to FIG. 4, the method may comprise measuring the resistance of a heat sensitive component adjacent to the battery cell at step 410. The method may further comprise comparing the measured resistance to a threshold resistance 421 at step 420. In an event that the measured resistance is below the threshold resistance, a thermal even has occurred in the battery cell adjacent to the heat sensitive component.

In an event that the thermal identification device comprises more than one heat sensitive component, the method comprises sequentially measuring the resistance of each heat sensitive component and comparing that measured resistance to the threshold resistance.

The method may be repeated at regular intervals.

In an event that it is determined that a thermal event has occurred, a notification may be provided. The notification may comprise sending a signal to a controller or processor, sending an electronic message or wireless message, turning on a light or buzzer, or other notification. The notification may be visible, audible, electronic, wireless, or otherwise.

1. A thermal event identification device to identify thermal events in a battery pack comprising at least one battery cell, the thermal identification device comprising:
a heat sensitive component comprising a substrate and a capsule containing an electrolyte, wherein:
the substrate is electrically conductive;
below a first temperature, a resistance of the substrate has a first resistance value; and
in an event that the heat sensitive component is heated to above the first temperature the electrolyte is released from the capsule such that the substrate is soaked in the electrolyte and the resistance of the substrate changes to a second resistance value;
a first electrical connection and a second electrical connection, wherein the heat sensitive component is electrically connected to the first and second electrical connections such that a resistance of the substrate of the heat sensitive component can be measured; and
a controller configured to determine whether a thermal event has occurred based on the resistance of the heat sensitive component, wherein in use, the heat sensitive component is configured to be adjacent to a battery cell.

2. The thermal identification device of claim 1, wherein the second resistance value is lower than the first resistance value.

3. The thermal event identification device of claim 1, further comprising:
two or more heat sensitive components and at least one additional electrical connection, wherein:
each heat sensitive component is electrically connected to two electrical connections such that a resistance of the substrate of each heat sensitive component can be measured individually;
the controller is configured to determine whether a thermal event has occurred at each heat sensitive component based on the resistance of each heat sensitive component; and
in use, each heat sensitive component is configured to be adjacent to a battery cell.

4. The thermal identification device of claim 3, wherein at least one electrical connection is common to more than one heat sensitive component, such that a resistance of the substrate of each heat sensitive component can be measured individually.

5. The thermal identification device of claim 1, further comprising:
an array of heat sensitive components arranged in an array of more than one row and more than one column, wherein:
each heat sensitive component is electrically connected to two electrical connections such that a resistance of the substrate of each heat sensitive component can be measured individually;
the controller is configured to determine whether a thermal event has occurred at each heat sensitive component based on the resistance of each heat sensitive component; and
in use, each heat sensitive component is configured to be adjacent to a battery cell.

6. The thermal identification device of claim 5, wherein each heat sensitive component in a row of heat sensitive components is connected to a common electrical connection and each heat sensitive component in a column of heat sensitive components is connected to a common electrical connection.

7. The thermal identification device of claim 1, wherein the capsule is embedded in the substrate.

8. The thermal identification device of claim 7, wherein the heat sensitive component comprises a plurality of capsules embedded in the substrate, the capsules containing an electrolyte.

9. The thermal identification device of claim 8, wherein the capsules are micro-capsules.

10. The thermal identification device of claim 1, further comprising a first conducting layer and a second conducting layer and wherein:
the first electrical connection is connected to the first conducting layer;
the second electrical connection is connected to the second conducting layer; and
the substrate is positioned between the first conducting layer and the second conducting layer such that the first and second conducting layer are electrically connected via the substrate.

11. The thermal identification device of claim 1, wherein the heat sensitive component further comprises one or more capsules containing a first dye and wherein in an event that the heat sensitive component is heated to above the first temperature the dye is released from the one or more capsules.

12. The thermal identification device of claim 11, wherein the heat sensitive component further comprises one or more capsules containing a second dye and wherein in an event that the heat sensitive component is heated to above a second temperature the dye is released from the one or more capsules.

13. A battery pack comprising:
two or more battery cells; and
a thermal event identification device according to claim 3, wherein each heat sensitive component is adjacent to a battery cell.

14. A method of identifying whether a thermal event has occurred in a battery cell of a battery pack, the method comprising:
measuring the resistance of a heat sensitive component adjacent to the battery cell, wherein:
the heat sensitive component comprises a substrate and a capsule containing an electrolyte;
the heat sensitive component is electrically conductive;
below a first temperature, the substrate has a first resistance value;
in an event that the heat sensitive component is heated to above the first temperature the electrolyte is released from the capsule such that the substrate is soaked in the electrolyte and the resistance of the substrate changes to a second resistance value;
the heat sensitive component is electrically connected to a first electrical connection and a second electrical connection such that a resistance of the substrate of the heat sensitive component can be measured; and
in an event that the measured resistance is below a threshold resistance, a thermal event has occurred in the battery cell adjacent to the heat sensitive component; and
comparing the measured resistance to the threshold resistance.

15. The method of claim 14 wherein the second resistance value is lower than the first resistance value.
